(19) United States
(12) Patent Application Publication
(10) Pub. No.: US 2026/0351043 A1
(43) Pub. Date: Nov. 5, 2026

(54) SYSTEM AND METHOD FOR ARTIFICIAL INTELLIGENCE BASED BEHAVIORAL FACIAL RECOGNITION

(71) Applicant: Davis Souza Alves, Winter Garden, FL (US)

(72) Inventor: Davis Souza Alves, Winter Garden, FL (US)

(21) Appl. No.: 19/558,647

(22) Filed: Mar. 6, 2026

Related U.S. Application Data
(60) Provisional application No. 63/797,176, filed on Apr. 30, 2025.

(51) Int. Cl. G06V 40/16; G06V 10/24

(52) U.S. Cl. CPC G06V 40/172; G06V 10/24; G06V 40/176

(57) ABSTRACT

A system and method for integrating facial recognition with artificial intelligence (AI) behavioral analysis by analyzing facial images using micro-expressions, emotional markers and psychodynamic interpretations and generating an investigative dossier of behavioral facial recognition. Using a specially configured application-specific AI model and specific data architectures and data sets facial behavioral analysis is conducted that is capable of interpreting images (e.g., static images) of the human face and producing a detailed behavioral report by using micro-expressions, emotional markers and psychodynamic interpretations. Through the specially configured application-specific AI model a functional specialization process is deployed that combines supervised fine-tuning, instruction-based adaptation (i.e., instruction tuning) and integration of specialized domain knowledge wherein the AI model has a modular architecture comprised of multiple AI microservices that are specifically designed for the identification, classification and interpretation of behavioral facial traits.

### CROSS-REFERENCE TO RELATED APPLICATION

This application claims the benefit of U.S. Provisional Patent Application No. 63/797,176 filed Apr. 30, 2025, which is hereby incorporated by reference herein in its entirety.

### FIELD OF THE INVENTION

The present invention relates generally to behavioral facial recognition, and more particularly to a system and method for utilizing artificial intelligence (AI) in analyzing facial images using micro-expressions, emotional markers and psychodynamic interpretations and generating an investigative dossier of behavioral facial recognition.

### BACKGROUND OF THE INVENTION

Behavioral facial recognition is an advanced technique that, among several approaches, uses the fixed marks of facial expressions to assess recurring emotions and the behavioral profile of individuals. Traditionally, this technique is applied through observation, but recent advances have allowed analysis to also be performed using static photos of faces. This is because repeated micro-expressions over time (e.g., the result of frequent emotions or psychological trauma) cause marks and wrinkles to become permanently fixed on the skin. These marks, combined with the study of neuroscience, provide valuable clues about a person's emotional and health state, contributing to their use in public safety contexts. Furthermore, neuroscience has shown that certain hormonal states, such as increased levels of cortisol (i.e., the stress hormone) can be “imprinted” on people's faces in a noticeable way. For example, people who experience high levels of stress often have characteristics such as reddened eyes, more rigid features and exacerbated expression lines.

Accordingly, there is a need for a technique for analyzing facial images using micro-expressions, emotional markers and psychodynamic interpretations and generating an investigative dossier of behavioral facial recognition specific to an individual indicative of their predominant behavioral characteristics.

### SUMMARY OF THE INVENTION

The present invention is directed to providing a system and method for utilizing application-specific AI in analyzing facial images using micro-expressions, emotional markers and psychodynamic interpretations and generating an investigative dossier of behavioral facial recognition specific to an individual indicative of their predominant behavioral characteristics. A multi-layer biometric platform is enabled that combines facial identification (i.e., who the person(s) is/are) and behavioral facial recognition (i.e., how the person(s) is/are).

In a first implementation of the invention, a computer-implemented for behavioral facial analysis is provided utilizing application-specific AI in analyzing facial images using micro-expressions, emotional markers and psychodynamic interpretations and generating an investigative dossier of behavioral facial recognition specific to an individual indicative of their predominant behavioral characteristics. The computer-implemented method comprising:
receiving at least one facial image of a target human individual;
invoking and executing a facial identification module, wherein the facial identification module executing performs the steps of:
   pre-processing the at least one facial image for normalization, facial alignment and lighting correction;
   extracting a plurality of facial vectors from the at least one facial image pre-processed;
   comparing the at least one facial image of the target human individual against a plurality of stored facial images using the plurality of facial vectors extracted, wherein the plurality of stored facial images comprises a respective stored facial image for a respective one registered individual of a plurality of registered individuals;
   determining an identity of the target human individual by matching the at least one facial image of the target human individual with a particular respective stored facial image for a respective one registered individual of the plurality of registered individuals, and if the matching is successful identifying the identity and an authorization status based on the at least one facial image of the target human individual matched;
   creating a facial identification data set comprising at least the identity and the authorization status identified associated with the target human individual;
   displaying the identity and the authorization status identified associated with the target human individual;
invoking and executing a behavioral facial recognition module, wherein the behavioral facial recognition module executing performs the steps of:
   receiving the at least one facial image and the facial identification data set created from the facial identification module;
   receiving a behavioral recognition analysis type selection, wherein the behavioral recognition analysis type selection is either behavioral analysis or thematic analysis;
   receiving an analysis data set associated with the behavioral recognition analysis type selection received;
   receiving an artificial intelligence (AI) textual analysis model selection;
   accessing a plurality of independent microservices, wherein each independent microservice of the plurality of independent microservices is specific to a particular facial feature and micro-expression identification;
   executing the AI textual analysis model selected and the plurality of independent of microservices for identifying, interpreting, and classifying one or more emotional markers extracted from the at least one facial image received by:
   extracting one or more behavioral facial traits from the at least one facial image received;
   autonomously analyzing and classifying the one or more behavioral facial traits extracted in accordance with at least the behavioral recognition analysis type selection received, the facial identification data set received, and the analysis data set associated with the behavioral recognition analysis type selection received;
   interpreting the one or more behavioral facial traits classified by a searching a semantic database of behavioral meanings; and
   generating, using the interpretation of the one or more behavioral facial traits classified, one or more behavioral facial recognition reports defining a behavioral profile specific to the target human individual.

In a second aspect, a data processing system is provided for executing the computer-implemented method for behavioral facial analysis utilizing application-specific AI in analyzing facial images using micro-expressions, emotional markers and psychodynamic interpretations and generating an investigative dossier of behavioral facial recognition specific to an individual indicative of their predominant behavioral characteristics.

In a third aspect, a non-transitory computer-readable medium having executable code stored thereon, that when executed, cause a data processing system to perform operations utilizing application-specific AI in analyzing facial images using micro-expressions, emotional markers and psychodynamic interpretations and generating an investigative dossier of behavioral facial recognition specific to an individual indicative of their predominant behavioral characteristics.

In a fourth aspect, a behavioral facial recognition application (alternatively referred to herein as an “app”) may be executed on the data processing system for executing the method operations for utilizing application-specific AI in analyzing facial images using micro-expressions, emotional markers and psychodynamic interpretations and generating an investigative dossier of behavioral facial recognition specific to an individual indicative of their predominant behavioral characteristics.

In another aspect, one or more report preferences are received and applied during the generation of behavioral facial recognition reports defining a behavior profile specific to the human individual.

In another aspect, the at least one facial image is a still facial photograph.

In another aspect, the at least one facial image is identified from a video.

In another aspect, a personality profile classification model is employed for extracting facial features.

In another aspect, the behavioral facial recognition module pre-populates one or more behavioral recognition forms using the behavioral recognition analysis type selection received, the facial identification data set received, and the analysis data set associated with the behavioral recognition analysis type selection received.

In another aspect, the personality profile classification model is one of: a Big Five Personality Theory model, a Theory of the Four Temperaments model, a Culture Map model, a Myers-Brigg Type Indicator® (MBTI) model or a Personality Disorders model.

In another aspect, fixed facial features and micro-expressions are employed for analyzing and classifying the behavioral facial traits.

In another aspect, at least one facial pattern is recognized that is indicative of an emotional state.

In another aspect, the recognized emotional state is one of stress, insecurity, tension, self-control or confidence.

In another aspect, content in the generated facial recognition reports is rephrased using a large language model (LLM).

In another aspect, each independent microservice of the plurality of independent microservices is trained in accordance with an annotated facial features dataset.

In another aspect, the annotated facial features dataset comprises data directed to eye movements, mouth movements, jaw movements, eyebrow movements, and wrinkles and symmetry patterns.

In another aspect, the behavioral profile specific to the human individual specifies one or more predominant behavioral characteristics of the human individual.

In another aspect, the extracted behavioral facial traits comprise one or more emotional markers, one or more facial micro-expressions and/or one or more psychodynamic characteristics.

In another aspect, one more dynamic facial micro-expressions are read from a video for use in detecting how the human individual reacts emotionally to specific stimuli and information contained in the video.

In another aspect, a facial image and a name associated with a human individual are employed for creating a digital behavioral profiles specific to the human individual by searching for a digital presence associated with the human individual as a function of online content and activities of the human individual.

The methods and systems described herein can be implemented by data processing systems, such as one or more smartphones, tablet computers, desktop computers, laptop computers, smart watches, wearable, audio accessories, on-board computer, and other user devices and consumer electronic devices. The methods and systems described herein can also be implemented by one or more data processing systems which execute executable computer program instructions, stored in one or more non-transitory machine readable media that cause the one or more data processing systems to perform the one or more methods described herein when the program instructions are executed. Thus, the embodiments described herein can include methods, data processing systems, and non-transitory machine readable media.

The above summary does not include an exhaustive list of all embodiments in this disclosure. All systems and methods can be practiced from all suitable combinations of the various aspects and embodiments summarized above, and also those disclosed in the detailed description below.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a high-level system interoperability architecture for implementing a multi-layer biometric platform in accordance with an embodiment;

FIG. 2 presents a high-level operational inter-module communication sequence diagram in accordance with an embodiment;

FIG. 3 presents a flowchart of illustrative operations for using application-specific AI in analyzing facial images using micro-expressions, emotional markers and psychodynamic interpretations and generating an investigative dossier of behavioral facial recognition in accordance with an embodiment;

FIG. 4A presents an illustrative architecture for application-specific AI for analyzing facial images using micro-expressions, emotional markers and psychodynamic interpretations and generating an investigative dossier of behavioral facial recognition in accordance with an embodiment;

FIG. 4B presents a high-level block diagram of an illustrative system architecture in accordance with an embodiment;

FIG. 5 presents a high-level block diagram of a cloud network services architecture for using application-specific AI in analyzing facial images using micro-expressions, emotional markers and psychodynamic interpretations and generating an investigative dossier of behavioral facial recognition in accordance with an embodiment;

FIG. 6 presents an illustrative data processing system configured for using application-specific AI in analyzing facial images using micro-expressions, emotional markers and psychodynamic interpretations and generating an investigative dossier of behavioral facial recognition in accordance with an embodiment;

FIG. 7 presents an illustrative architecture for a behavioral facial recognition app in accordance with an embodiment;

FIG. 8 presents a high-level logic diagram of the innovation kernel for the behavioral facial recognition system in accordance with an embodiment;

FIG. 9 presents a high-level architecture for a behavioral inference engine employed by the behavioral recognition module in accordance with an embodiment; and

FIGS. 10A and 10B present illustrative personality classification models used by the behavioral facial recognition app in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a system and method that integrates facial recognition with AI behavioral analysis for analyzing facial images using micro-expressions, emotional markers and psychodynamic interpretations and generating an investigative dossier of behavioral facial recognition. That is, in accordance with the principles of the disclosed embodiments, a multi-layer biometric platform is enabled that combines facial identification (i.e., who the person(s) is/are) and behavioral facial recognition (i.e., how the person(s) is/are). The multi-layer biometric platform disclosed hereunder enables single-person behavior analysis and/or multi-person comparative behavioral analysis. An inferential behavioral engine employs (i) facial extraction with emotional vectors that identifies micro-tensions and morphological patterns associated with behavioral traits, (ii) thematic projection with theoretical matrices that cross-references data with various models to allows for a psychological, criminological and behavioral assessments to be made; and (iii) narrative analysis with analytical report(s) such that numerical references returned by the algorithmic model analysis are converted into coherent and useable behavioral analysis. In accordance with the principles of the disclosed embodiments, an AI-specific application solution is utilized for facial behavioral analysis that is capable of interpreting images (e.g., static images) of the human face and producing a detailed behavioral report by using micro-expressions, emotional markers and psychodynamic interpretations. An application-specific AI model is employed using a functional specialization process that combines supervised fine-tuning, instruction-based adaptation (i.e., instruction tuning) and integration of specialized domain knowledge wherein the AI model has a modular architecture comprised of multiple AI microservices that are specifically designed for the identification, classification and interpretation of behavioral facial traits. Each microservice is an autonomous computational algorithm, trained with unique datasets composed of actual annotated images. For example, to identify downward wrinkles at the corners of the mouth (a micro-expression associated with sadness), numerous specific images are employed through a supervised learning process. That is, the subject application-specific AI model and operations will receive one or more facial images for image recognition purposes and after such image recognition the microservices will analyze and classify detected facial features/traces autonomously, determine the meaning corresponding to each facial feature/trace and generate one or more behavioral facial recognition reports (e.g., a behavioral facial dossier with personal, professional, clinical, and/or investigative applicability) defining a behavioral profile specific to the human individual. Importantly, the disclosed embodiments provide advantageous improvements to at least one practical application (i.e., behavioral facial recognition and application-specific AI) such that facial images may be analyzed through an application-specific AI model using micro-expressions, emotional markers and psychodynamic interpretations and generating an investigative dossier of behavioral facial recognition. In this way, this complex facial analysis may be used to identify valuable characteristics of an individual's emotional and health states thereby contributing to the use of this technology in a variety of applications including, but not limited to, public safety. This solves security problems in trying to identify individuals with dangerous intentions (e.g., a terrorist trying to pass an airport security checkpoint) in a rapid, efficient, and accurate manner thereby decreasing the potential of such third-party safety and security threats.

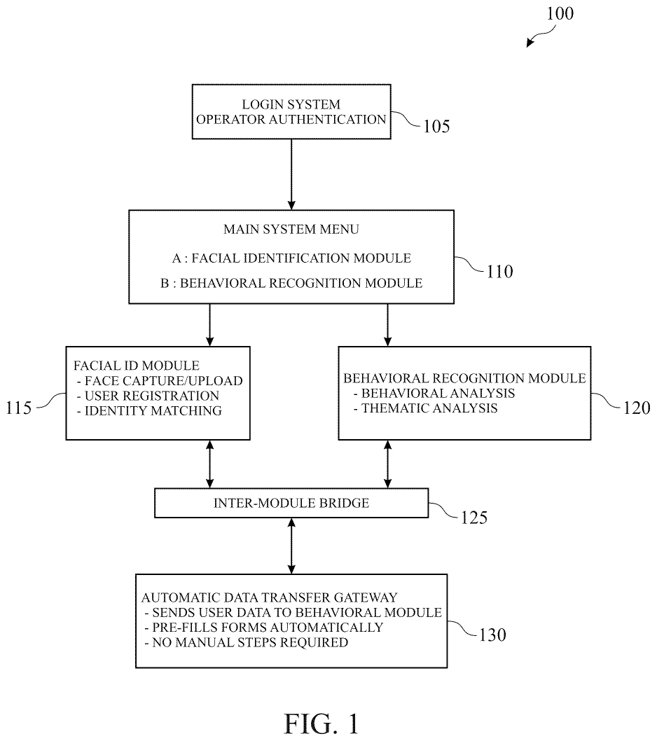

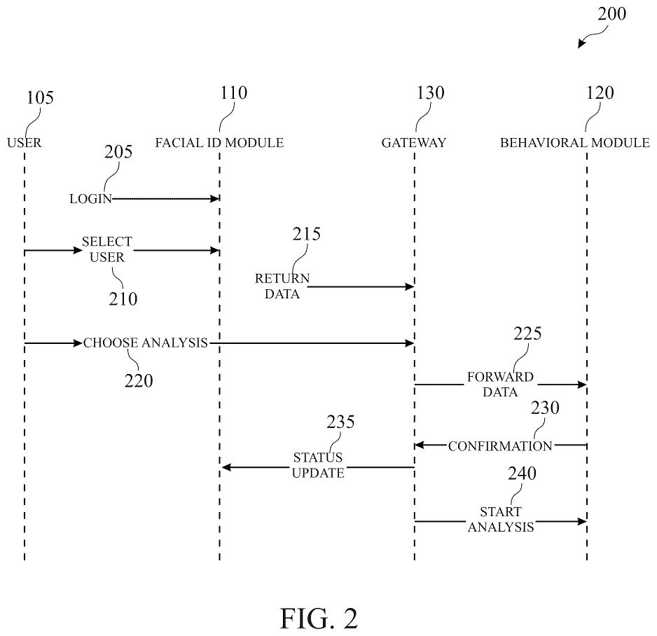

As noted, the principles of the disclosed embodiments employ a multi-layer biometric platform is enabled that combines facial identification (i.e., who the person(s) is/are) and behavioral facial recognition (i.e., how the person(s) is/are). The multi-layer biometric platform disclosed hereunder enables single-person behavior analysis and/or multi-person comparative behavioral analysis. Turning our attention to FIGS. 1 and 2, a high-level system interoperability architecture 100 is shown in FIG. 1 for implementing the multi-layer biometric platform hereunder and a high-level operational inter-module communication sequence diagram 200 is shown delineating various inter-module communications in accordance with an embodiment. In particular, at block 105 and operational sequence 205 certain system administrative and user-level operations are executed including, but not limited to, user login and authentication. At block 110 and operational sequence 210 a selection is made as to whether single user or multi-user analysis is desired and the user will select either one or multiple individuals that have been previously registered with the platform. For example, such selections may be made from a presenting searchable listing of registered individuals. Alternatively, the user may also add information to register a new individual (e.g., full name, email address, position/group (internal classification), image upload and other personal data). Importantly, in accordance with the principles of the disclosed embodiments, the facial identification module 115 is dedicated exclusively to traditional biometric identification and is separate from the behavioral analysis module 120 functionality. As such, the facial identification module 115 facilitates delivering an access management system based on facial biometrics, using static photography, for identifying pre-registered individuals, enabling attendance tracking, entry authorization, and user management through an integrated database. Illustratively, the facial identification module 115 may use a facial recognition algorithm configured for executing a convolutional neural network (CNN) which is a type of machine learning in which a model learns to perform classification tasks directly on an image, video, text, or sound. The CNN algorithm allows the model to perform classification tasks directly on the image for purposes of facial recognition in accordance with an embodiment. Further, facial identification module 115 may further provide for displaying a dashboard of the total number of registered users, recording completed identifications (with date/time), classification between authorized and denied identifications, exporting function such as to Portable Document Format (PDF) files and Excel files, and internal audit mechanism (e.g., an access log). Thus, at operational sequence 215 the system captures a photograph of the individual or receives an image uploaded manually. The captured image undergoes at least the following: pre-processing (normalization, facial alignment, lighting correction); extraction of unique facial vectors; and comparison with the local database for the purpose of identifying and validating the individual as a registered and displaying the authorization status thereof. After the user selected a registered individual identified from the facial identification processing, at operational sequence 220, the operations turn using inter-module bridge 125 to the behavioral recognitions aspects of the multi-layer biometric platform as further discussed in greater detail hereinbelow. Advantageously, the integration of and interoperability between the facial identification module 115 and the behavioral recognition module 120 provides an innovative mechanism to fully leverage the facial identification processing and biometric information detailed thereby (e.g., name, email, and photographs) to be automatically provided to the behavioral recognition module 120 as a starting point for the advanced behavioral analysis facilitating a continuous pipeline between biometric identification and behavioral evaluation. For purposes of the current discussion, the user selects a preference for behavioral analysis or thematic analysis. The automatic data transfer gateway 130 will then at operational sequence 225, 230, 235, and 240, respectively, automatically transfers the selected individual's data (e.g., name, email, photo used for identification, metadata, etc.) to the corresponding form in the other subsystem, pre-fill all necessary information, reducing manual errors and accelerating operational flow, and initiate the behavioral analysis flow without the need to recapture or resend images. Before proceeding with further aspects of the disclosed embodiments, a more detailed discussion of the behavioral facial recognition features of the principles of the disclosed embodiments will now be presented.

Behavioral facial recognition is different from other facial recognition techniques because it can go beyond conventional biometric identification, such as identity verification based on static facial features. While traditional systems focus on aspects such as facial geometry, distance between the eyes and facial proportions to authenticate individuals, the behavioral facial recognition technique herein delves deeper into the analysis of micro-expressions and fixed features associated with emotions and psychological states. This approach uses insights from neuroscience to identify behavioral signals, such as elevated levels of stress or emotional tension, captured in static photos or videos, making it a more comprehensive and strategic tool. In the context of public safety, this technology offers significant advantages over traditional facial recognition. While the latter is widely used for access control, surveillance and suspect identification, behavioral facial recognition allows the detection of suspicious intentions and behaviors based on emotional and hormonal patterns. For example, in urban operations, it can identify individuals who show signs of extreme anxiety or emotional agitation in public spaces, potentially preventing crimes before they occur. This functionality broadens the scope of action of security forces, transforming facial recognition into a predictive tool rather than just a reactive one in accordance with the principles of the disclosed embodiments. In a territorial security scenario, such as borders or airports, the application-specific AI technique herein delivers a behavioral facial recognition that can be used to identify high-risk behaviors or malicious intent in real-time. In overly sensitive environments, such as immigration control, its ability to analyze emotional and hormonal signals can provide valuable information for screening passengers and identifying potential threats. Furthermore, in areas vulnerable to terrorist attacks, the disclosed embodiments herein provide an additional layer of defense by allowing authorities to analyze patterns of micro-expressions associated with high levels of stress or nervousness, often present in individuals with dangerous intentions. In the context of wars and conflicts, the application-specific AI technique herein may be used to monitor and analyze emotions and behaviors of military personnel or even civilians in conflict areas, helping to identify hostile intentions or situations of imminent risk. Furthermore, its application in intensive surveillance environments, such as military bases or conflict zones, allows military commands to detect subtle emotional changes in individuals, assisting in preventive operations or defense strategies. This strategic use of the application-specific AI principles herein in behavioral facial recognition reinforces its potential as a differentiated and indispensable tool for public security in its most diverse dimensions.

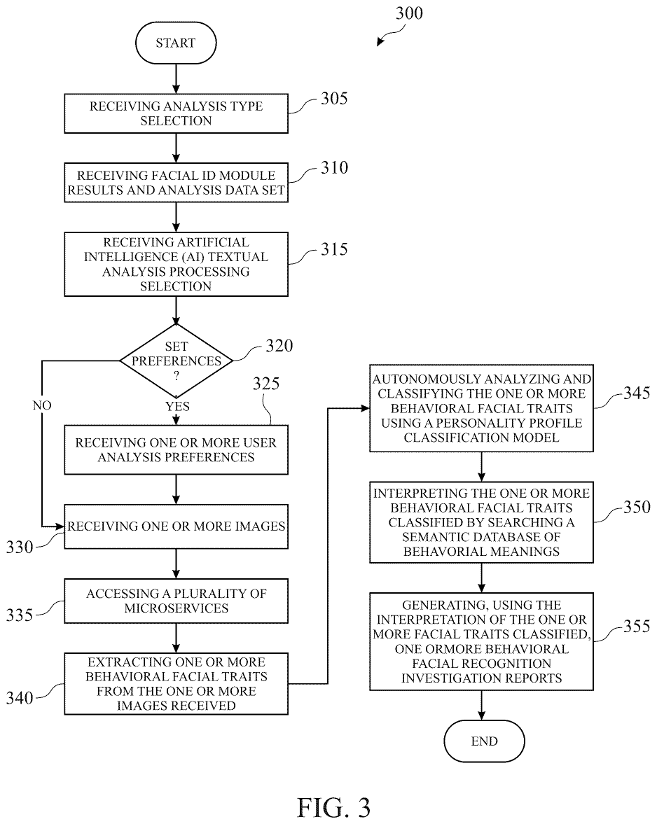

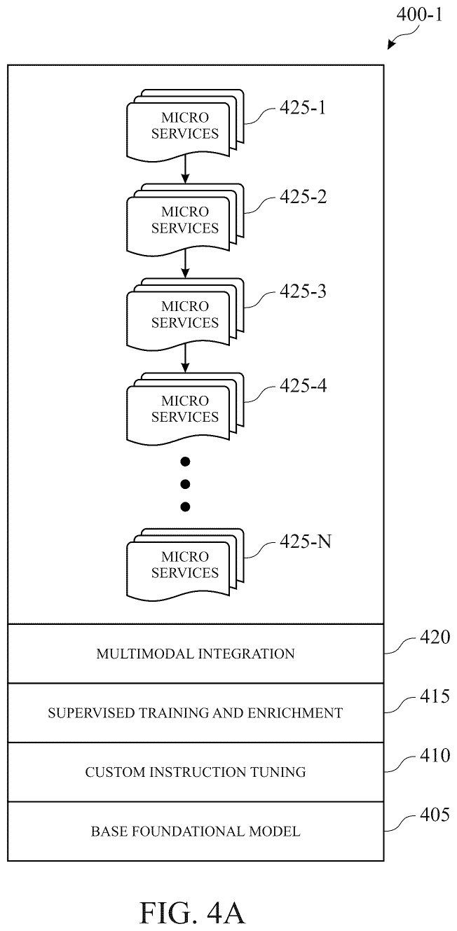

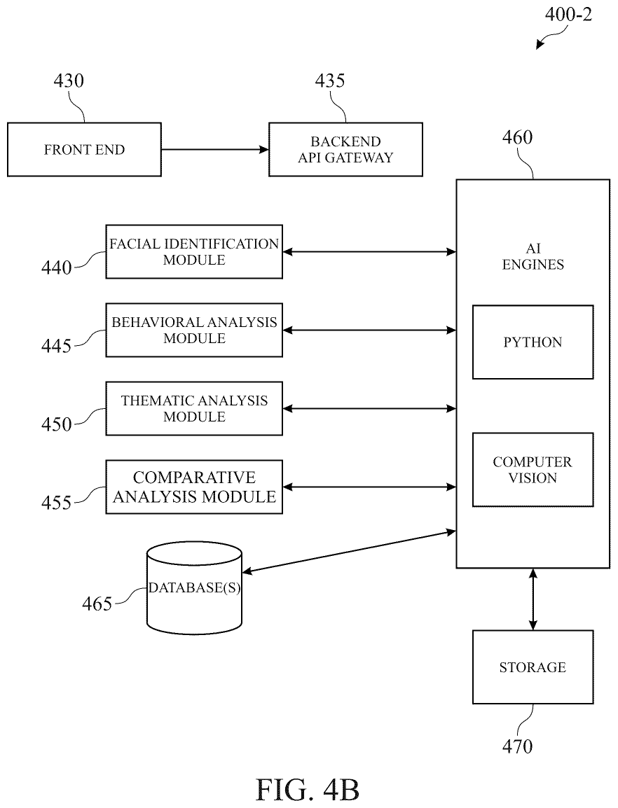

Turning our attention to FIGS. 3 and 4 which will be discussed together, FIG. 3 shows a flowchart of illustrative operations 300 for using application-specific AI in analyzing facial images using micro-expressions, emotional markers and psychodynamic interpretations and generating an investigative dossier of behavioral facial recognition in accordance with an embodiment. Supplementing FIG. 3, FIG. 4 presents an illustrative architecture 400 for application-specific AI for analyzing facial images using micro-expressions, emotional markers and psychodynamic interpretations and generating an investigative dossier of behavioral facial recognition in accordance with an embodiment. More particularly, at step 305, receiving a behavioral analysis type selection. That is, in accordance with the subject embodiment, a user may select a particular analysis type including, but not limited to, individual behavioral analysis, comparative analysis, and thematic analysis. Individual behavioral analysis may also include, but is not limited to, general profiles, personal performance, professional performance, criminal behavior, and psychoanalytic profiles. Comparative analysis may include analysis between two (2) faces. Thematic analysis may include various theoretical third-party model/approaches including, but not limited to, the Big Five Personality Theory model, the Theory of the Four Temperaments model, the Culture Map model, the Myers-Brigg Type Indicator® model or the Personality Disorders model. At step, 310, receiving the facial identification module results and an analysis data set associated with the behavioral analysis type selection received wherein such analysis data set illustratively comprises the name of the person(s) under investigation, contact information for recipient(s) of the final facial recognition investigation report(s), and the language(s) to be used for the analysis. Of course, the analysis data may be tailored to any desired investigation such that the data set may include a wide variety of information depending upon that desired investigation. At step 315, receiving an AI textual analysis model selection. Thus, in accordance with the subject embodiment, the user may select the AI textual analysis model to be employed which illustratively includes the application-specific AI model detailed in this disclosure but may may include an external third-party model (e.g., GPT-Generative Pre-trained Transformer). At step 320, a determination is made wither the user desires to set any preferences and if so, at step 325 receiving one or more user analysis preferences. For example, the user may want the content to be rephrased in the generated report and/or to have scientific references included in the report. Then, at step 330, receiving one or more facial images of a human individual to be analyzed which may include a still facial photograph and/or a facial image identified from video content. With respect to video content, in an embodiment, dynamic facial micro-expression(s) may be read from the video and for detecting how an individual reacts emotionally to specific stimuli and information contained in the video. That is, dynamic facial micro-expressions may be read for detecting how an individual reacts emotionally to specific stimuli and information in the video and allowing for mapping of signs of tension, acceptance, rejection, or emotional congruence during the reception of such information. In a further embodiment, a facial image(s) and a name associated with the human individual, may be used to create a digital behavioral profiles specific to the human individual by searching for a digital presence associated with the human individual as a function of online content and activities of the human individual (e.g., social media), and that digital behavioral profile may be employed in the generation of the behavioral facial recognition report(s). In this way, in accordance with the principles of the disclosed embodiments, the relationship between facial expressions and emotions is leveraged, and how trauma and recurrent emotional states (e.g., stress) influence the formation of facial features (e.g., wrinkles and other visible marks) which are used as points of behavioral analysis.

Importantly, in accordance with the principles of the disclosed embodiments, the subject application-specific AI model and operations will receive one or more facial images for image recognition purposes and after such image recognition the microservices will analyze and classify detected facial features/traces autonomously, determine the meaning corresponding to each detected facial feature/trace and generate one or more behavioral facial recognition reports (e.g., a behavioral facial dossier with personal, professional, clinical, and/or investigative applicability) defining a behavioral profile specific to the human individual. Turning our attention to FIG. 4A and the illustrative architecture 400-1 for this application-specific AI the associated operations comprise base foundational model 405, custom instruction tuning 410, supervised training and enrichment 415, multimodal integration 420, and microservices 425-1, 425-2, 425-3, 425-4 through 425-N. In essence, the application-specific AI model and associated operations detailed in this disclosure operate on three (3) analytical levels: technical detection, semantic interpretation, and interpretative text generation. In accordance with the subject embodiment, the base foundational model 405 is a general purpose language model (e.g., the Meta Llama family of open-source large language models (LLMs) created by Meta AI, with the latest version being Llama 4) that are trained on vast amounts of text data, enabling them to understand and generate human-like text. As will be seen below, independent microservices (each responsible for identifying a specific facial marker) are integrated with LLMs for textual adaption and paraphrasing in the generation of behavioral reports. Custom instruction tuning 410 comprises specific human sciences related to the interpretation of facial recognition such as Physiognomy, Morpho psychology, Visagism, and Behavioral Psychology. Supervised training and enrichment 415 is directed to supervised training with datasets annotated and organized according to behavioral parameters and facial expression with emphasis on behavioral interpretation based on facial recognition. Physiognomy may be used as a complementary tool to raise initial hypotheses about emotional traits or behavioral tendencies in still images. Morphopsychology will be considered for its focus on the relationship between facial shapes and emotional or behavioral tendencies as this may offer useful insights into the analysis of proportions and patterns in a person's face. Facial micro-expressions and FACS code (Facial Action Coding System (FACS) which is a system for categorizing and measuring facial expressions by analyzing the movements of specific measures), in turn, will form the core of behavioral facial recognition exercise. Micro-expressions, being rapid and involuntary, can reveal underlying emotions that the person has not been able to suppress, while the FACS code provides a detailed technical system for mapping and interpreting facial muscle movements. Multimodal integration 420 and the technical detection analytical level are directed to coupling computer vision (CV) with natural language processing (NLP) for facial image analysis with the generation of interpretive reports thereby instituting a multi-modal pipeline of computer vision (for detection) and NLP (for interpretation).

Microservices 425-1, 425-2, 425-3, 425-4 through 425-N are directed to multiple AI microservices that are specifically designed for the identification, classification and interpretation of behavioral facial traits using a decoupled microservices model, each responsible for specific functions including, facial identification, behavioral analysis, thematic analysis, comparative analysis, LLM/Ollama, and orchestration and API gateway. As will be understood by those skilled in the art, a microservice is a cloud-native architectural approach where a software application is structured as a collection of small, independent, and loosely coupled services that communication with each other (typically, through Application Programming Interfaces (APIs) or messaging protocols) enabling independent deployment and scalability. Each microservice is an autonomous computational algorithm, trained with unique datasets composed of actual annotated images. For example, a microservice may be directed to wrinkles and associated symmetry patterns to identify downward wrinkles at the corners of the mouth (a micro-expression associated with sadness), numerous specific images are employed through a supervised learning process. Similar procedures are used for each relevant facial feature such as eyes, eyebrow shape, expression lines, jaw angel, subtle movements of the eyes, mouth, jaw, and eyebrows, etc. In an embodiment, The following models are used for analyses: beard shape, cheek size, concave chin, chin height, chin shape, chin size, chin width, ear style, eye color, eye shape, eye size, eye type, eyebrow asymmetry, eyebrow height, eyebrow style, eyebrow thickness, eyebrow width, face shape, facial elongation, facial symmetry, face width, forehead height, forehead width, glabella, hair color, hair shape, jaw-line, lip filter, lip thickness, mouth shape, mouth size, mouth style, mouth width, crooked nose, nose size, nose style, nose width, temples, facial thirds, age, ear shape, and gender. Thus, each of these elements is interpreted, using a specific microservice, from a behavioral and emotional perspective in accordance with the aforementioned semantic interpretation and interpretive text generation analytical layers. In an embodiment, these raw facial data cross-referencing procedures may include applying semantic processing in combination with a specifically configured a semantic behavioral meaning database developed using a variety of psychoanalytic, psychosomatics, non-verbal, and emotional profiling sources. In accordance with the embodiments herein, this semantic behavioral meaning database may be effectively utilized for identifying the meaning(s) corresponding to each facial feature analyzed. In this way, the microservices employed in accordance with the principles of the disclosed embodiments perform behavioral facial recognition as opposed to biometric identification as used in existing techniques and are therefore not limited to facial identity recognition and verification but are further capable of identifying, interpreting, and classifying emotional markers, facial micro-expressions, and psychodynamic characteristics extracted from image(s).

Turning our attention to FIG. 4B, a high-level block diagram of an illustrative system architecture 400-2 is shown in accordance with an embodiment. In an embodiment, the frontend 430 of the system hereunder is implemented in React/Next.js and the backend/API gateway 435 employs NestJS. AI engines 460 comprises at least computer vision services running in Python. Illustratively, the frontend 430 sends images or camera references and the backend 435 routes requests to specialized microservices (i.e., facial identification module 440, behavioral analysis module 445, thematic analysis module 450, and comparative analysis module 455). Each model executed by the specialized microservice has a single responsibility and defined API contract to ensure consistency. These specialized microservices evaluate and return analyses as detailed throughout this disclosure. A behavioral inference engine in the backend 435 consolidates results and generates various reports. Illustratively, this behavioral mechanism integrates facial embeddings and geometric attributes thereby producing non-diagnostic statistical inferences which are oriented toward general behavioral profiles. Final data is stored in database 465 and/or storage 470.

Taking a closer look at the behavioral analysis module 445, this module focuses on analyzing static photos, extracting behavioral patterns, personality tendencies, and thematic profiles based on facial morphology and micro-signals derived from psycho-behavioral models. Quantitative and qualitative guidelines and analysis is employed through various analysis types and steps as follows:

### Standard′ Analysis

Includes general personality and behavior guidelines, formed by hybrid models:
Assertiveness
Self-esteem
Resilience
Dominance/submission traits
Impulsivity
Sociability
Emotional processing

This analysis serves as the “backbone” for all others.

### Personal Performance Analysis

Evaluates how an individual tends to behave in:
Personal life
Relationships
Spontaneous decisions
Conflict management
Domestic and social life

Indicators include:
As a friend
As a spouse
As a lover
As a family member

Each indicator is represented in the interface with individual icon buttons.

### Professional Performance Analysis

Focuses on behavior in work environments:
Leadership
Subordination
Ethics
Reliability
Negotiation style
Emotional intelligence

Available titles:
As a leader
As a subordinate
As an employee
As a freelancer
As a competitor

### Criminal Behavior (Criminal and Behavioral Profile Module)

One of the more advanced modules which allows identification of tendencies associated with:
Manipulative behavior
Complicity
Risk of violation
Criminal modus operandi
Propensity to lie
Planning ability

Categories:
As instigator
As leader
As participant
As accomplice
As witness
As informant
As victim

This module directly supports security and border control agencies.

### Psychoanalytic Profile

Analyzes predominant emotional patterns and defense mechanisms. Examples:
Projection
Rationalization
Dissociation
Reaction formation
Recurring neurotic mechanisms

Can be used to predict emotional responses and stress tolerance.

### Persuasion Analysis (“How to Influence”)

Evaluates:
Individual's persuasive communication style
Response to affective bonds
Emotional connection factors

Useful for commercial and relationship analyses.

### Avoidance Analysis (“What to Avoid”)

Analyzes:
Behavioral triggers
Stress points
Stimuli that may generate conflict
Patterns of emotional breakdown

Useful in negotiations, interviews, security, and decision-making.

In this way, the behavioral analysis module 445 and associated analysis provided various benefits in critical areas such as security, immigration, and forensics. The available behavioral analysis processing quickly provides behavioral risk indicators, fraud and manipulation tendencies, signs of aggressiveness, impulsivity, and emotional incongruities, possible patterns of criminal behavior, collaboration profile during interviews, and/or factors that increase or decrease an individual's reliability. These capabilities make such processing applicable to immigration and border control, security forces, investigation departments, screening of visitors and employees, and/or fraud prevention.

Taking a closer look at the thematic analysis module 450, this module is configured to meet international standards for psychological, criminological, and behavioral assessment. It allows analysts to select globally recognized scientific methodologies and generate a comprehensive report on emotional patterns, cognitive profiles, personality traits, and risk indicators-all from a single static photograph. This module functions as an advanced layer of behavioral facial recognition, providing precise, theory-driven thematic diagnostics and expanding applications in government institutions, public safety, intelligence, counterterrorism, immigration, and organizational integrity. This module is configured with various official methodological sets, each designed for specific purposes as follows:

### I. DSM-5—Personality Disorders

Assessment aligned with the world's most widely used diagnostic manual:
Paranoid
Schizoid
Schizotypal
Antisocial
Borderline
Histrionic
Narcissistic
Avoidant
Dependent
Obsessive-Compulsive

### II. Big Five Personality Traits

Measures the five universal dimensions:
Openness
Conscientiousness
Extraversion
Agreeableness
Neuroticism

### III. Hippocrates'Four Temperaments

Classical classification:
Choleric
Sanguine
Phlegmatic
Melancholic

### IV. MBTI 16 Profiles

Evaluates cognitive preferences:
Introversion/Extraversion
Intuition/Sensing
Thinking/Feeling
Judging/Perceiving

### V. Cultural Map

Essential for:
Immigration
International interviews
Multicultural environments

Includes factors such as:
Direct vs. indirect communication
Confrontation vs. diplomacy
Hierarchical vs. consensual decision-making

### VI. Aggressiveness Indicators

Designed for public safety:
Violent impulsivity
Risk of physical confrontation
Emotional reactivity
Predisposition to hostile behavior

### VII. Manipulation Indicators

Used in investigations, interviews, and audits:
Strategic lying
Manipulative charm
False docility
Emotional exploitation
Deception

Turning our attention back to FIG. 3, at block 335, accessing a plurality of independent microservices and as noted above each independent microservice of the plurality of independent microservices is specific to a particular facial feature, micro-expression identification and personality aspect. Using these microservices provides for certain facial detection and segmentation such that facial image(s) are processed autonomously to identify specific facial points based on psychanalytic expertise and semantics to measure the intensity of these traits. Thus, facial patterns are recognized that indicate emotional states (subtle or otherwise) including, but not limited to stress, insecurity, tension, self-control and/or confidence. This is further facilitated by cross-referencing this facial image raw data with semantic meaning content (e.g., stored in the aforementioned semantic behavioral meaning database) that allows for behavioral inferences to be established thereby linking facial characteristics to behavioral tendencies including, but not limited to, trustworthiness (e.g., facial symmetry, smoothness of features and/or absence of lip tension, emotional congruence (e.g., compatibility between facial expression and baseline traits), and stress or deception (e.g., involuntary contractions around the mouth, eyes, or jaw indicating internal micro-conflict(s)). This analysis recognizes and leverages a principle that most traits are identified through skin marks or facial components, mainly due to behavioral repetition or micro-expressions in addition to known human genetic factors. Further, the application-specific AI model herein interprets patterns and aligns them with recognized psychological models/theories (e.g., Big Five, MBTI, etc.) in order to suggest possible psychological tendencies of individual(s) and it should be noted that the classification made is non-deterministic and represents a possible predominate trait(s) rather than a definitive diagnosis. In this way, the application-specific AI model herein operates similar to the existing Facial Action Coding System (FACS) which is a system for categorizing and measuring facial expressions by analyzing the movements of specific measures. More particularly, executing the AI textual analysis model selected and the plurality of independent of microservices for identifying, interpreting, and classifying one or more emotional markers extracted from the at least one facial image received by (a) at block 340, extracting one or more behavioral facial traits from the at least one facial image received; (b) at block 345, autonomously analyzing and classifying, in accordance with at least the behavioral analysis type selection received and the analysis data set associated with the behavioral analysis type selection received, the one or more behavioral facial traits extracted; (c) at block 350, interpreting the one or more behavioral facial traits classified by a searching a semantic database of behavioral meanings; and (d) at block 355, generating, using the interpretation of the one or more behavioral facial traits classified, one or more behavioral facial recognition reports defining a behavioral profile specific to the human individual. In an embodiment, fixed facial features and micro-expressions are autonomously analyzed and classified for extracting behavioral facial trait(s) in accordance with the behavioral analysis type selected and the analysis data set associated with that behavioral analysis type. In accordance with the disclosed embodiments, the behavioral facial recognition reports are generated by extracting text from the semantic behavioral meaning database and/or using AI-generated interpretative text with personalized rewriting/rephrasing (e.g., using an LLM). In this way, the principles of the disclosed embodiments enable the highly accurate and flexible delivery of interpretative behavioral facial recognition reports through leveraging computer vision, natural language processing and expert knowledge.

The behavioral facial recognition aspects disclosed herein processes, organizes, and delivers psychological, emotional, and behavioral trends based on different structures and identified patterns. The following is a behavioral engineering view of the employed and invoked architectures and modules:

### Behavioral Extraction Architecture (Layer-Based Behavioral Mapping)

From a single static photograph/image, the system identifies and projects various behavioral macro dimensions, each composed of inferential sub-traits as follows:

### Cognitive Profile

The model generates inferences about:
Reason↔Emotion balance
Alternating use of logic, critique, and creativity
Strategic decision-making capacity under pressure
Cognitive flexibility across different environments

Module responsible for inferring basic cognitive structure (processing type, adaptability, reasoning modes).

### Socialization

The algorithm identifies patterns such as:
Selective extroversion
Context-dependent charisma
Movement between openness and emotional reserve
Diplomacy and maintenance of social harmony

Mapping relational dynamics, detecting social breadth, withdrawal, emotional control, and group responses.

### Decision-Making

System inferences include:
Analytical planning
Strategic caution
Balanced use of intuition and logic
Rapid adaptation when necessary

Identification of dominant decision-making style and pattern-change triggers.

### Vulnerabilities

The model detects:
Rigid perfectionism
High self-criticism
Creative blocks
Over-sensitivity to failure

Submodule mapping internal limitations and emotional performance risks.

### Relationship Style

Inferences include:
Seeking deep connections
Need for emotional reciprocity
Withdrawal under frustration
Strong capacity for emotional support

Module for intimate interactions and depth of bonding.

### Development Potentials

The system identifies areas for growth:
Emotional flexibility
Reduction of self-criticism
Assertive communication of expectations
Openness to creative mistakes

Predictive module suggesting recommended behavioral adjustments.

### Resilience and Defense Mechanisms

The system points out:
Tendency to rationalize
Protective emotional distancing
Difficulty integrating emotions fully

Mapping self-preservation and emotional recovery strategies.

### Identity Expression

Inferences:
Clarity of values
Integrity and moral consistency
Difficulty in flexibility of convictions
Tension between authenticity and adaptation

Module for identity consistency and principle expression.

### Attitude Toward Time

The system indicates:
Future orientation
Anxiety over outcomes
Tendency to neglect the present

Analysis of predominant psychological temporal focus.

### Emotional Regulation

Inferences:
High self-control
Difficulty expressing vulnerability
Tendency to emotional accumulation

Emotional management and impulse control module.

### Empathy and Sensitivity

The system identifies:
High empathy
Perception of emotional nuances
Risk of emotional overload

Calculation of empathy index and risk of emotional burnout.

### Sexuality and Affectivity

Detects:
Emotional caution
Moderate affectivity
Fear of intimate exposure

Affective-behavioral profile in trust and bonding contexts.

### Self-Care Capacity

Identifies:
Neglect of self due to excessive responsibilities
Risk of burnout
Difficulty prioritizing emotional health

Physical and emotional energy management module.

### Creativity

The algorithm infers:
High creative potential
Blockage due to perfectionism
Emotional sensitivity as a source of creativity

Assessment of practical creative level and associated blocks.

### Leadership

The system indicates:
Inspiring and empathetic leadership
Possible adoption of authoritarian control under pressure
Contrast between cooperation and imposition

Mapping of situational leadership style.

### Motivations

Detects:
Search for recognition
High work ethic
Intense self-demand

Module for internal drivers and satisfaction factors.

### Conflict Response Style

Inferences:
Preference for mediation
Tendency to avoid confrontation
Difficulty with self-assertion

Map of response strategies to adverse situations.

### Relationship With Vulnerability

Detects:
Resistance to exposing weaknesses
Fear of judgment
Emotional rigidity

Module estimating degree of emotional openness and interpersonal trust.

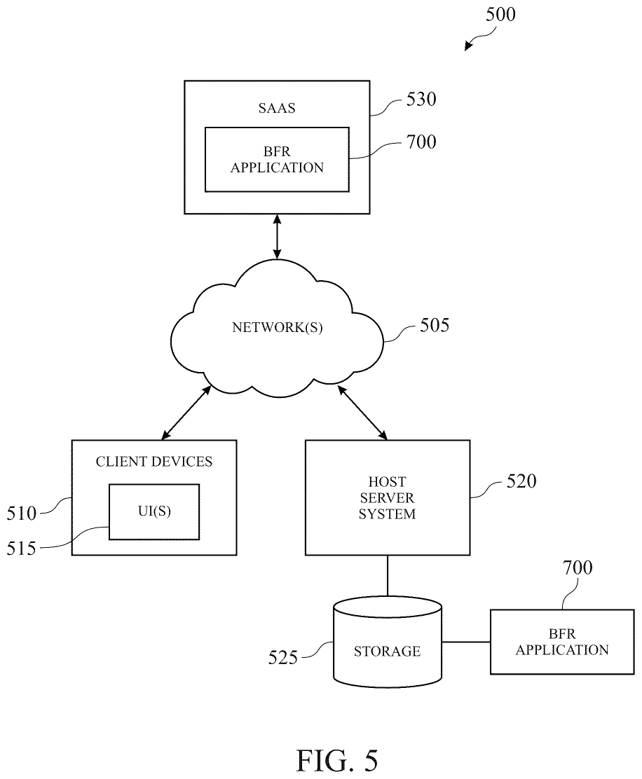

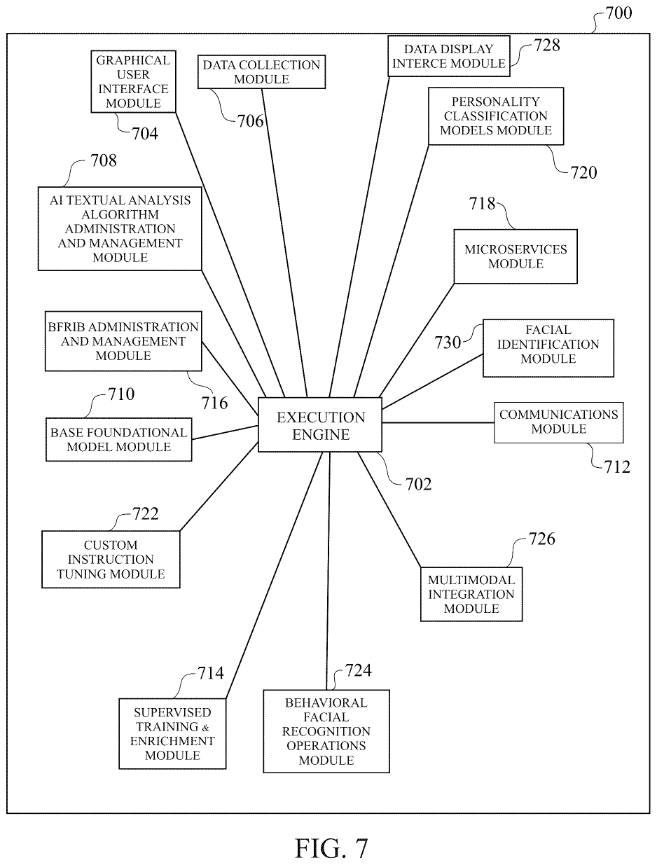

Turning our attention to FIG. 5, a high-level block diagram of a cloud network services system architecture 500 for facilitating the analyzing of facial images using micro-expressions, emotional markers and psychodynamic interpretations and generating an investigative dossier of behavioral facial recognition in accordance with an embodiment. As shown for instance in FIG. 5, the cloud network services architecture 500 includes client device(s) 510, SaaS host 530 configured for hosting behavioral facial recognition (BFR) application 700 (see also, FIG. 7), and host server system 520 communicatively coupled with storage 525 and storing the BRF application 700 and the semantic behavioral meaning database, for example, client device(s) 510, host server system 520 and SaaS host 530 may communicate with each other over a network(s) 505. As noted previously, the AI model herein, the BFR app 700 and associated operations are classified as an application-specific AI, located at the top of the AI stack. The solution may use as a base open source language models, such as LLaMA (Meta), with adaptation by specific instructions (instruction-tuned LLM), in addition to integrating proprietary AI and interoperability with external models (such as GPT) for text processing. Its modular architecture is composed of independent microservices, specialized in the identification of facial features and micro-expressions, using a multimodal approach (computer vision+NLP) and is operable on flexible infrastructure in cloud environments (e.g., AWS, GCP), and with GPU support (e.g., third-party semiconductors). In addition to running in the cloud, the application-specific AI model may be configured to operate in local infrastructures (e.g., on-premise), and may be executed in closed environments with its own AI-ready servers, without relying on public clouds. This flexibility allows for adoption in scenarios with high information security requirements, digital self-sufficiency, compliance with internal policies, and alignment with contemporary trends of “de cloudification” and digital sovereignty. Further, the application-specific AI model and system can also be classified as Cognitive, Explainable AI (XAI) and Human-Centered AI, as it combines technical intelligence, interpretability, and scientific basis in the analysis of human behavior from the face. It should be noted that any numbers of client devices, SaaS hosts or SaaS instances, and/or other hosts may be present in various embodiments. Additionally, any combination of the components illustrated in FIG. 5 may be present in cloud network services architecture 500, according to embodiments.

Network(s) 505 may comprise any type of communication links that connect computing devices and servers such as, but not limited to, the Internet, wired or wireless networks and portions thereof, point-to-point connections, local area networks (LANs), enterprise networks and the like. Illustratively, network(s) 505 may comprise a cloud network comprising server(s), access point(s) and database(s). Cloud, cloud service, cloud server and cloud database are broad terms and are to be given their ordinary and customary meaning to one of ordinary skill in the art and includes, without limitation, any database, data repository or storage media which store content for various applications including, but not limited to, the aforementioned semantic meaning behavioral database. A cloud service may include one or more cloud servers and cloud databases that provides for the remote storage of content as hosted by a third-party service provider or operator. A cloud server may include an HTTP/HTTPS server sending and receiving messages in order to provide web-browsing interfaces to client web browsers as well as web services to send data to integrate with other interfaces. The cloud server may be implemented in one or more servers and may send and receive content in a various forms and formats, user supplied and/or created information/content and profile/configuration data that may be transferred from or stored in a cloud database. The term “cloud computing” as referred to herein implies the on-demand availability of computer system resources, especially data storage and computing power, without direct active management by the user. The term is generally used to describe data centers available to many users over the Internet. Large clouds, predominant today, often have functions distributed over multiple locations from central servers. If the connection to the user is relatively close, it may be designated an edge server. Clouds may be limited to a single organization (e.g., enterprise clouds), be available to many organizations (e.g., public cloud), or a combination of both (e.g., hybrid cloud).

A cloud database may include one or more physical servers, databases or storage devices as dictated by the cloud service's storage requirements. The cloud database may further include one or more well-known databases (e.g., an SQL database) or a fixed content storage system to store content, user profile information, configuration information, administration information and any other information necessary to execute the cloud service. In various embodiments, one or more networks providing computing infrastructure on behalf of one or more users may be referred to as a cloud, and resources may include, without limitation, data center resources, applications (e.g., software-as-a-service or platform-as-a-service) and management tools. Where databases are described, it will be understood by one of ordinary skill in the art that alternative database structures to those described may be readily employed, and other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

SaaS host 530 may comprise one or more server computers or computing devices, which may include one or more distributed or “cloud-based” servers. SaaS host 530 may be configured to host one or more SaaS applications such as the BRF application 700. Applications hosted by SaaS host 530 may respectively comprise one or more APIs. These APIs may be configured to allow API calls (e.g., queries) that are specific to the hosted applications, or may be common/standard APIs configured to accept calls from various host servers.

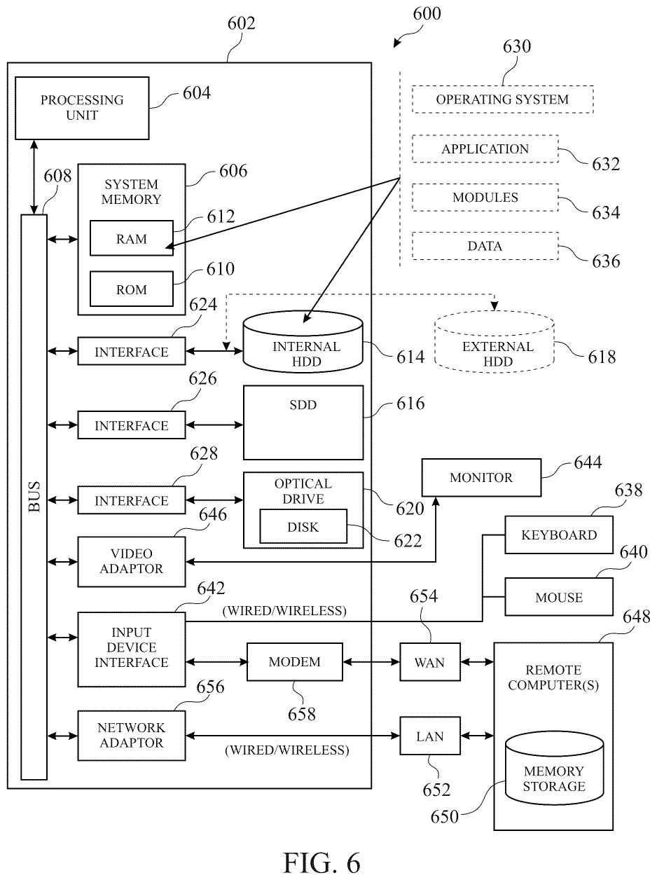

Host server system 520 may comprise one or more server computers or computing devices, which may include one or more distributed or “cloud-based” servers, and may also include internal and/or external storage, such as, but not limited to, the storage 525. Any internal and/or external storage may be distributed, according to embodiments. Host server system 520 may be configured as a data processing system 602 (see, FIG. 6) to host applications/resources. Such applications/resources may be embedded with other external applications, such as information sharing services, email services, productivity applications, social media services, etc. It is contemplated herein that any number of applications may be stored and/or executed by the host server system 520.

Client device(s) 510 may be any type of data processing system (e.g., configures as data processing system 602 as shown in FIG. 6), including without limitation, a terminal, a personal computer, a laptop computer, a tablet device, a smart phone, etc. that may be used by users to interact with applications/services, including to create, access, modify, delete, etc., resources of the applications/services. Likewise, client device(s) 510 may be used by owners of resources and administrators of applications/services to respectively configure permissions. Client device(s) 510 may be configured to provide user requests for resources over network 505 to host server system 520 to enable users to access such resources, as described herein. In various embodiments, a user may utilize a user interface(s) (UIs) 515 for providing the requests through networks 505, to host server system 520 and/or to Saas host 530. In embodiments, client device 510 may include a stored instance of such a UI, e.g., received from the host server system 520, the Saas host 530, or as a component of the client device 510. In embodiments, UI(s) 515 may be any type of service/application UI, browser, client or electronic communication application, messaging application, portal, and/or the like, and may be related to a user experience component or a front-end component of the host server system 520 and/or Saas host 530.

Turning our attention to FIG. 6, an illustrative computing environment 600 is shown of a data processing system 602 operable to execute the systems and architectures in accordance with the disclosed embodiments herein. In order to provide additional context for various aspects thereof, FIG. 6 and the following discussion are intended to provide a brief, general description of a suitable computing environment 600 in which the various aspects of the claimed subject matter can be implemented. While the subject description is in the general context of computer-executable instructions that may run on one or more computers, those skilled in the art will recognize that the subject matter as claimed also can be implemented in combination with other program modules and/or as a combination of hardware and software. Generally, program modules include routines, programs, components, data structures, etc., that perform particular tasks or implement particular abstract data types. Moreover, those skilled in the art will appreciate that the inventive methods can be practiced with other computer system configurations, including single processor or multiprocessor computer systems, minicomputers, mainframe computers, as well as personal computers, hand-held computing devices, microprocessor-based or programmable consumer electronics and the like, each of which can be operatively coupled to one or more associated devices. The illustrated aspects of the disclosed embodiments may also be practiced in distributed computing environments where certain tasks are performed by remote processing devices that are linked through a communications network. In a distributed computing environment, program modules can be located in both local and remote memory storage devices. A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information, and which can be accessed by the computer.

With reference again to FIG. 6, the illustrative computing environment 600 for implementing various aspects of the disclosed embodiments includes the data processing system 602 including a processing unit 604, a system memory 606 and a system bus 608. The system bus 608 couples system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. The processing unit 604 may include both general and special purpose microprocessors and may be the sole processor or one of multiple processors of the device. Further, the processing unit 604 may comprise one or more central processing units (CPUs) and may include, be supplemented by, or incorporated in, one or more application-specific integrated circuits (ASICs) and/or one or more field programmable gate arrays (FPGAs). The system memory 606 may also be utilized for storing temporary variables or other intermediate information during the execution of the instructions by the processing unit 604. The system memory 606 may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The data processing system 602 further includes an internal hard disk drive (HDD) 614, which internal hard disk drive 614 may also be configured for external use in a suitable chassis (not shown), a solid-state drive (SDD) 616, and an optical disk drive 620, (e.g., reading a CD-ROM disk 622 or, to read from or write to other high capacity optical media such as the DVD). The hard disk drive 614, SDD 616 and optical disk drive 620 can be connected to the system bus 608 by a hard disk drive interface 624, an SDD interface 626 and an optical drive interface 628, respectively. External HDD 618 may also be included as a supplementary memory drive. The drives and their associated computer-readable media provide nonvolatile storage of data, data structures, computer-executable instructions, and so forth. For the data processing system 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed embodiments.

A number of program modules can be stored in the drives and random access memory (RAM) 612 and/or read-only memory (ROM) 610, including an operating system 630, one or more application programs 632 (e.g., the BFR app 700), other program modules 634 and program data 636. All or portions of the operating system, applications, modules, and/or data can also be cached in the RAM 612. It is to be appreciated that the claimed subject matter can be implemented with various commercially available operating systems or combinations of operating systems. A user can enter commands and information into the data processing system 602 through one or more wired/wireless input devices, e.g., a keyboard 638 and a pointing device, such as a mouse 640. Other input devices (not shown) may include a microphone, an infrared (IR) remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, a serial port, a game port, a USB port, an IR interface, etc. A monitor 644 or other type of display device is also connected to the system bus 608 via an interface, such as a video adaptor 646. In addition to the monitor 644, the data processing system 602 (e.g., a computer) typically includes other peripheral output devices (not shown), such as speakers, printers, etc.

The data processing system 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the data processing system 602, although, for purposes of brevity, only a memory/storage device 650 is illustrated. The logical connections depicted include wired/wireless connectivity to LAN 652 and/or larger networks, e.g., a wide area network (WAN) 654. Such LAN and WAN networking environments are commonplace in offices, enterprises, and companies, and facilitate enterprise-wide computer networks, such as intranets, all of which may connect to a global communications network (e.g., the Internet). When used in a LAN networking environment, the data processing system 602 is connected to the local network 652 through a wired and/or wireless communication network interface or adapter 656. The network adaptor 656 may facilitate wired or wireless communication to the LAN 652, which may also include a wireless access point disposed thereon for communicating with the wireless adaptor 656. When used in a WAN networking environment, the data processing system 602 can include a modem 658 or may be connected to a communications server on the WAN 654 or has other means for establishing communications over the WAN 654, such as by way of the Internet. The modem 658, which can be internal or external and a wired or wireless device, is connected to the system bus 608 via the input device interface 642. In a networked environment, program modules depicted relative to the data processing system 602, or portions thereof, can be stored in the remote memory/storage device 650. It will be appreciated that the network connections shown are illustrative and other means of establishing a communications link between the computers can be used.

The data processing system 602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk), and user device. This includes at least Wi-Fi and Bluetooth® wireless technologies. Thus, the communication can be a predefined structure as with a conventional network or simply an ad hoc communication between at least two devices. Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.llx (a, b, g, etc.) to provide secure, reliable, fast wireless connectivity. A Wi-Fi network can be used to connect computers to each other, to the Internet, and to wired networks.

Turning our attention to FIG. 7, an illustrative architecture for the operation of the behavioral facial recognition app 700 is presented in accordance with an embodiment. As will be appreciated, the architecture may be used, illustratively, in conjunction with the cloud network services architecture 600, the Saas host 630 and/or the data processing system 602 for launching and executing the behavioral facial recognition app 700 and its associated operations. As shown, the architecture for the operations of the behavioral facial recognition app 700 provides for the facial identification module and behavioral recognition module aspects disclosure herein and provides several interfaces and engines used to perform a variety of functions such as the collection, aggregation, manipulation, processing, analyzing, verification, authentication, and display of applicable real-time information and data that are useful to realize the delivery of behavioral facial recognition operations of the disclosed embodiments. More particularly, data display interface module 728 and communications module 712 are used to facilitate the input/output and display of electronic data and other information to users employing the data processing system 602 (e.g., a touch screen of the data processing system 602) and executing the behavioral facial recognition app 700. The data collection module 706 facilitates data gathering from the plurality of users and other third parties.

Execution engine 702 may be employed to deliver the behavioral facial recognition services herein through the execution of the behavioral facial recognition app 700. In such delivery, the execution engine 702 will operate and execute, as further detailed herein below, with at least the following program modules: graphical user interface module 704, data collection module 706, AI textual analysis algorithm administration and management module 708, base foundational model module 710, communications module 712, supervised training and enrichment module 714, behavioral facial recognition investigative brief (BFRIB) administration and management module 716, microservices module 718, personality classification models module 720, custom instruction tuning module 722, behavioral facial recognition operations module 724, multimodal integration module 726, and facial identification module 730. In embodiments, the graphical user interface module 704, data display interface module 728, and the communications module 712 are used to facilitate the input/output and display of electronic data and other information (e.g., a graphical user interface) to users employing the data processing system 602 (e.g., a touch screen) and executing the behavioral facial recognition app 700. The data collection module 706 facilitates information collection from the plurality of users. The data collection module 706 may also be used to collect a variety of behavioral facial recognition information from other virtual and/or electronic sources accessible via the Internet and individual third-party websites hosted thereon. The operations executed by each and every of the foregoing modules are, for example, as discussed throughout this disclosure.

Advantageously, the principles of the disclosed embodiments provide for the integration of facial recognition with AI behavioral analysis for analyzing facial images using micro-expressions, emotional markers and psychodynamic interpretations and generating an investigative dossier of behavioral facial recognition. Improvements to computer architecture and functionality are provided through the operations of the AI algorithms and the use of specific data architectures and data sets for facial behavioral analysis that is capable of interpreting images (e.g., static images) of the human face and producing a detailed behavioral report by using micro-expressions, emotional markers and psychodynamic interpretations. Through a specially configured application-specific AI model a functional specialization process is deployed that combines supervised fine-tuning, instruction-based adaptation (i.e., instruction tuning) and integration of specialized domain knowledge wherein the AI model has a modular architecture comprised of multiple AI microservices that are specifically designed for the identification, classification and interpretation of individual behavioral facial traits. Each microservice is an autonomous computational algorithm, trained with unique datasets composed of actual annotated images. In this way, the disclosed embodiments provide advantageous improvements to behavioral facial recognition applications whereby facial images may be analyzed through an application-specific AI model using micro-expressions, emotional markers and psychodynamic interpretations and generating an investigative dossier of behavioral facial recognition. Significantly, this complex facial analysis may be used to identify valuable characteristics of an individual's emotional and health states thereby contributing to the use of this technology in a variety of applications including, but not limited to, public safety. This solves security problems in trying to identify individuals with dangerous intentions (e.g., a terrorist trying to pass an airport security checkpoint) in a rapid, efficient, and accurate manner thereby decreasing the potential of such third-party safety and security threats.

Those skilled in the art will appreciate that the present disclosure contemplates the use of systems configurations and/or computer instructions that may perform any or all of the operations involved in the behavioral facial recognition operations herein. The disclosure of computer instructions that include, for example, the behavioral facial recognition app 700 and the data processing system 602 instructions is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the applications herein may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including LANs, WANs, through the Internet (e.g., using an Internet Service Provider), or the connection may be made to external computers.

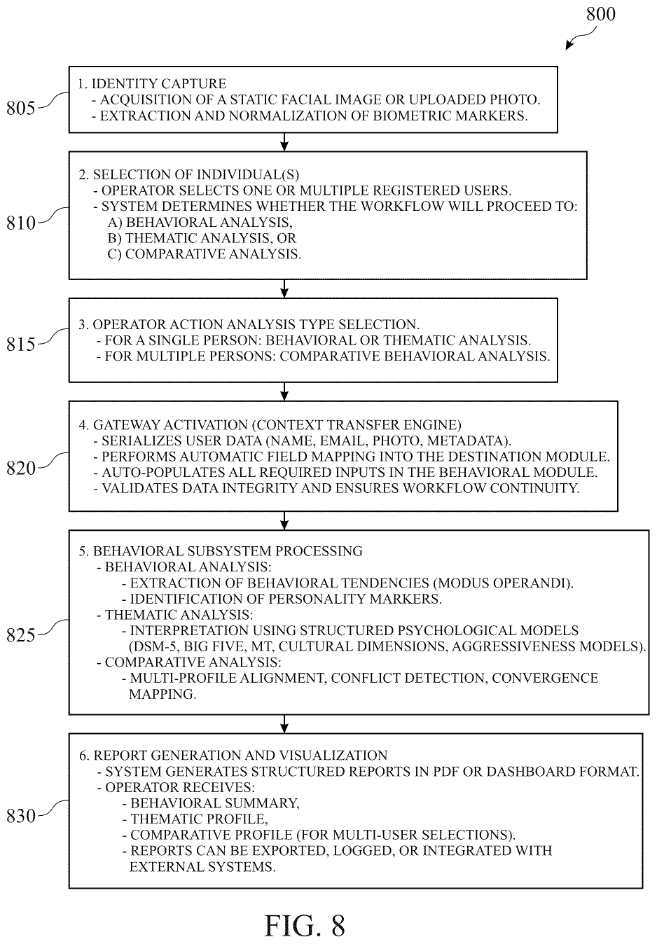

FIG. 8 presents a high-level logic diagram of the innovation kernel 800 for the behavioral facial recognition system in accordance with an embodiment. Identify capture, at block 805, provides for the acquisition of a static facial image or an uploaded photograph associated with the target individual for analysis. Using the acquire static image, pre-processing is executed (normalization, facial alignment, lighting correction) with extraction of unique facial vectors and comparison with the local database for the purpose of identifying and validating the individual(s) as a registered and displaying the authorization status thereof, as detailed previously. At block 810, there is a selection of an individual or individuals from the registered individual(s) identified. Based on whether a single individual or multiple individuals have been selected, the system will automatically determine which type of analysis may be selected by the user at block 815 (i.e., single individual: behavioral or thematic analysis; multiple individuals: comparative behavioral analysis). At block 820, the automatic data transfer gateway (e.g., see FIG. 1) is engaged which among other things serializes user data (e.g., name, email address, photograph, and metadata), performs automatic field mapping into a destination module, automatically populated all required fields in the behavioral recognition module, and validates data integrity and ensure workflow continuity. Behavioral subsystem processing, at block 825, provides for the (i) behavioral analysis: extraction of behavioral tendencies and identification of personality markers; (ii) thematic analysis: interpretation using structured psychological models (e.g., Diagnostic and Statistical Manual of Mental Disorders, Fifth Edition (DSM-5), Big Five, MBTI, Cultural Dimensions and Aggressiveness Models); and (iii) comparative analysis: multi-profile alignment, conflict detection, and convergence mapping. The final output provided, at block 830, includes but is not limited to structured reports and/or dashboards, behavioral summaries, thematic profiles, and comparative profiles. In this way, the innovation kernel 800 in accordance with the principles of the disclosed embodiments provides technological improvements to the computer system and the application-specific AI models that include (i) a chained workflow between independent subsystems (i.e., facial identification vs. behavioral recognition) thereby reinforcing a clear separation between biometric identification and behavioral analysis, (ii) an automatic context transfer mechanism (i.e., the automatic data transfer gateway 130) for facilitating the interconnection between the two independent facial identification and behavioral recognition subsystems, (iii) the use of advanced behavioral analyses as a function of static photograph or image this type of psychological processing pipeline based on a static photograph/image is substantially differentiating from conventional systems, and (iv) modular processing with three distinct types of analysis (i.e., behavioral, thematic, and comparative).

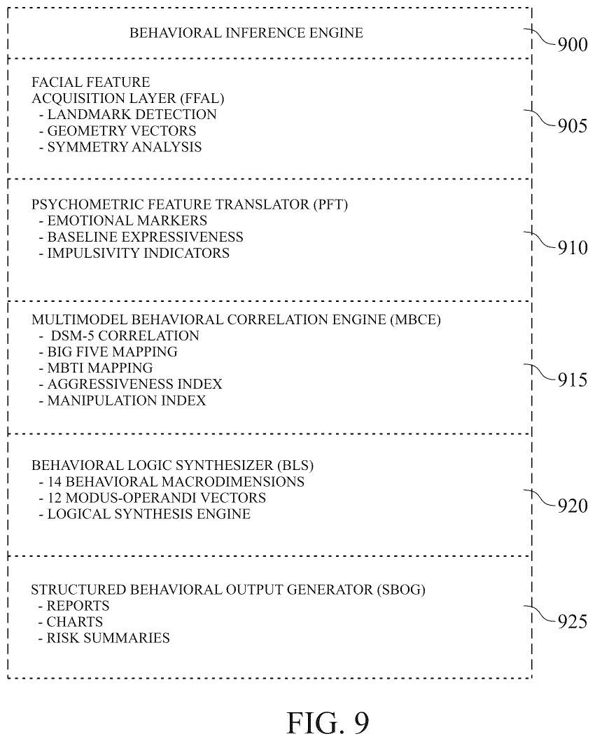

Further highlighting such technological improvements, FIG. 9 presents a high-level architecture for a behavioral inference engine 900 employed by the behavioral recognition module in accordance with an embodiment. The behavioral inference engine 900 provides technological advancements that include: (i) using only a single static photo to produce 40+ behavioral inferences; (ii) combining facial morphometrics with psychometric models; (iii) generating an interpretive narrative report, not just numerical data; (iv) enabling interoperability with thematic, comparative, and cross-modality analysis; (v) creating its own Modus Operandi matrix; and (vi) transforming visual data into operational decisions applicable to immigration, security, and intelligence. More particularly, facial feature acquisition (FFAL) layer 905 is responsible for the collection, isolation, and normalization of facial vectors through detection of facial landmarks, extraction of geometric micro-vectors and facial tensions, standardization of proportions, tilt, and symmetry, and the normalization for internal calculation scales. The output results a set of numerical matrices representing facial topology, asymmetry, muscle tonicity, basal expressiveness, and micro-structural rigidity. The psychometric feature translator (PFT) layer 910 provides for the conversion of facial vectors into preliminary psychometric markers. This layer converts geometric data into raw emotional and behavioral indicators including but not limited to expressivity index, basal emotional stability, potential impulsivity (via micro-tensions), social tension (openness x withdrawal), and dominance x submission. The output results in a preliminary emotional map. The multi-model behavioral correlation engine (MBCE) layer 915 provides for cross-referencing raw markers with scientific models. The MBCE compares preliminary data with standardized behavioral database including but not limited to DSM-5 (personality disorders), Big Five (five personality factors), MBTI (16 cognitive profiles), Hippocrates' temperaments, Cultural Map, Aggressiveness Indicators, and Manipulation Indicators. Each model is weighted by the MBCE for determining which theoretical patters best explain the collected facial data. The output results in theoretical compatibility matrices, emotional and behavioral risk vectors, and possible psychosocial trends. The behavioral logic synthesizer (BLS) layer 920 is directed to logical synthesis and final behavioral profile construction. This layer transforms multiple psychometric vectors into a coherent interpretation divided into the following:
1. Behavioral macro dimensions, including:
   Emotional regulation
   Cognitive style
   Decision-making
   Defense mechanisms
   Socialization
   Vulnerabilities
   Leadership profiles
Internal motivators
   Conflict response
   etc.;
2. Modus operandi vectors, including:
   Assertiveness
   Self-control
   Self-criticism
   Collaboration
   Imposition
   Egocentrism
   Hesitation
   Weakness
   and others

These are all then automatically reorganized into standardized interpretative narratives with psychological and operational coherence. The structured behavioral output generator (SBOG) layer 925 provides for the generation of final human-readable report and content (e.g., PDF, HTML, or API) ensuring consistency, standardization, and auditability. This layer converts all prior content into thematic reports, percentage charts, comparative matrices, lists of behavioral trends, synthesized psychological analysis, professional and relational profiles, risk indicators, and behavioral predications.

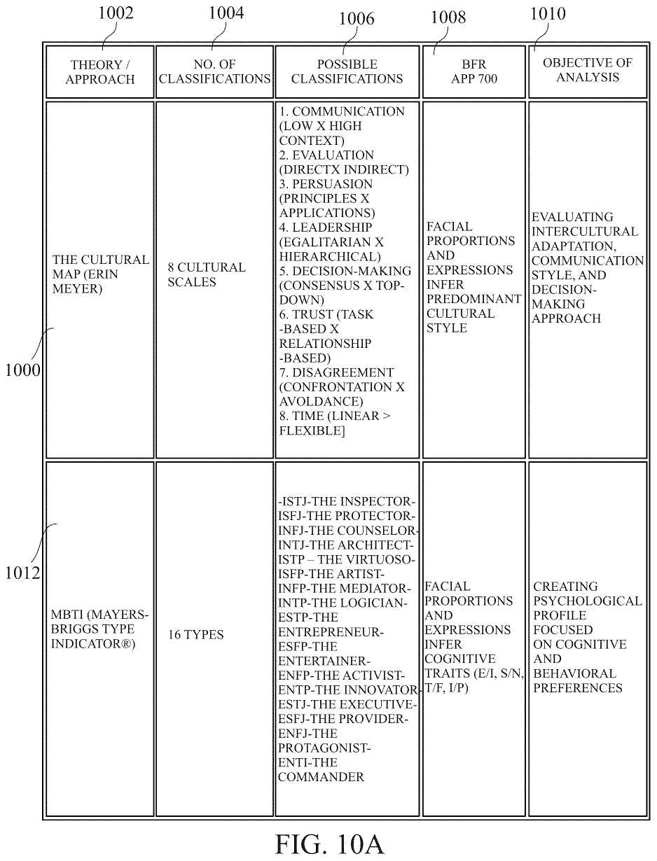

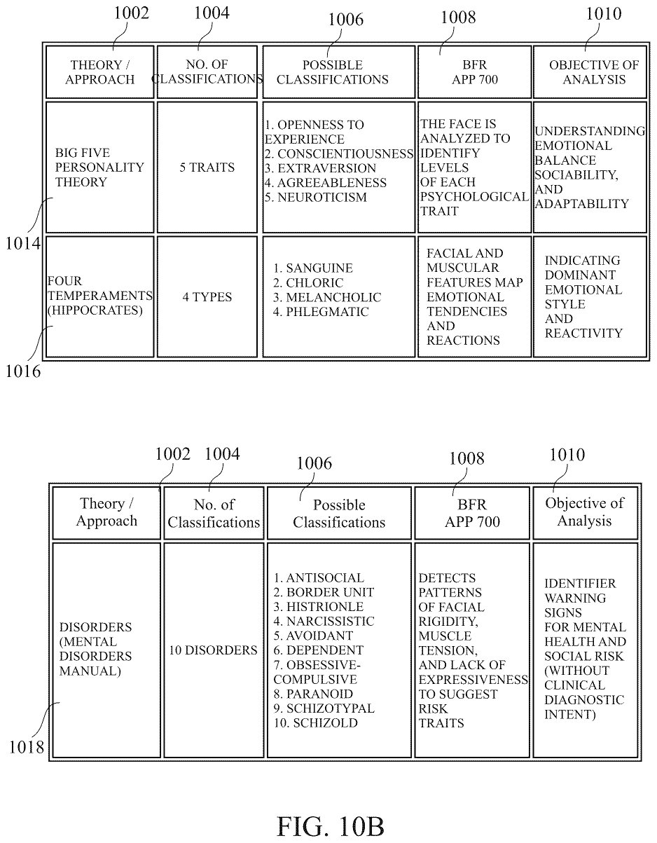

Turning our attention to FIGS. 10A and 10B, illustrative personality classification models are presented as used by the application-specific AI model and the BFR app 700 in accordance with an embodiment. More particularly for each personality classification model 1000, 1012, 1014, 1016, and 1018 there is the specification of the theory/approach 1002, number of classifications 1004, possible classifications 1006, uses 1008 in the BFR app 700, and the objective of analysis 1010. For example, with respect to personality classification model 1000 (i.e., The Cultural Map) the application-specific AI model herein by and through the BFR app 700 shows uses 1008 of facial proportions and expressions for inferring predominant cultural style when analyzing the received facial image(s) as detailed above. That is, as detailed above, the application-specific AI model herein interprets patterns and aligns them with recognized psychological models/theories (e.g., the personality classification models 1000, 1012, 1014, 1016, and/or 1018) in order to suggest possible psychological tendencies of individual(s). With respect to the personality classification model 1000 in this illustration the objective of the analysis 1010 being evaluating intercultural adaptation, communication style, and decision-making approach.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention. A description of an embodiment with several components in communication with each other does not imply that all such components are required. On the contrary, a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and/or textual instructions; applets; pre-compiled code; interpreted code; compiled code; and computer programs. Various programming languages can be employed to create one or more of the applications herein, structured in a variety of manners, such as object-oriented programming languages (e.g., Objective-C, Java, or C++) or procedural programming languages (e.g., C or assembly language). For example, applications developed using the ANDROID™ or IOS™ software development kit (SDK) may be mobile software running on a mobile operating system such as IOS™, ANDROID™, or another mobile operating system. In this example, the applications may invoke application programming interface (API) calls provided by the operating system to facilitate functionality described herein. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, wired communications networks, and computer networks (e.g., an intranet, an extranet, a local-area network, or a wide-area network).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-transitory, non-volatile media, volatile media, and transmission media. Non-volatile media include, for example, optical or magnetic disks and other persistent memory. Volatile media include dynamic random access memory (DRAM), which typically constitutes the main memory. Transmission media includes coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth®, 4G, 5G, etc.

Where databases are described, it will be understood by one of ordinary skill in the art that alternative database structures to those described may be readily employed, and other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a non-transitory computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units. A “network” may refer to a number of computers and associated devices that may be connected by communication facilities. A network may involve permanent connections such as cables or temporary connections such as those made through the telephone or other communication links. A network may further include hard-wired connections (e.g., coaxial cable, twisted pair, optical fiber, waveguides, etc.) and/or wireless connections (e.g., radio frequency waveforms, free space optical waveforms, acoustic waveforms, etc.). Examples of a network may include: an internet, such as the Internet; an intranet; a LAN; a wide area network (WAN); and a combination of networks.

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a GUI, or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that a certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A computer-implemented method for behavioral facial analysis comprising:
receiving at least one facial image of a target human individual;
invoking and executing a facial identification module, wherein the facial identification module executing performs the steps of:
pre-processing the at least one facial image for normalization, facial alignment and lighting correction;
extracting a plurality of facial vectors from the at least one facial image pre-processed;
comparing the at least one facial image of the target human individual against a plurality of stored facial images using the plurality of facial vectors extracted, wherein the plurality of stored facial images comprises a respective stored facial image for a respective one registered individual of a plurality of registered individuals;
determining an identity of the target human individual by matching the at least one facial image of the target human individual with a particular respective stored facial image for a respective one registered individual of the plurality of registered individuals, and if the matching is successful identifying the identity and an authorization status based on the at least one facial image of the target human individual matched;
creating a facial identification data set comprising at least the identity and the authorization status identified associated with the target human individual;
displaying the identity and the authorization status identified associated with the target human individual;
invoking and executing a behavioral facial recognition module, wherein the behavioral facial recognition module executing performs the steps of:
receiving the at least one facial image and the facial identification data set created from the facial identification module;
receiving a behavioral recognition analysis type selection, wherein the behavioral recognition analysis type selection is either behavioral analysis or thematic analysis;
receiving an analysis data set associated with the behavioral recognition analysis type selection received;
receiving an artificial intelligence (AI) textual analysis model selection;
accessing a plurality of independent microservices, wherein each independent microservice of the plurality of independent microservices is specific to a particular facial feature and micro-expression identification;
executing the AI textual analysis model selected and the plurality of independent of microservices for identifying, interpreting, and classifying one or more emotional markers extracted from the at least one facial image received by:
extracting one or more behavioral facial traits from the at least one facial image received;
autonomously analyzing and classifying the one or more behavioral facial traits extracted in accordance with at least the behavioral recognition analysis type selection received, the facial identification data set received, and the analysis data set associated with the behavioral recognition analysis type selection received;
interpreting the one or more behavioral facial traits classified by a searching a semantic database of behavioral meanings; and
generating, using the interpretation of the one or more behavioral facial traits classified, one or more behavioral facial recognition reports defining a behavioral profile specific to the target human individual.
